(19) United States
(12) Patent Application Publication
(10) Pub. No.: US 2020/0021853 A1
(43) Pub. Date: Jan. 16, 2020

(54) SYSTEMS AND METHODS FOR SIGNALING SCALABLE VIDEO IN A MEDIA APPLICATION FORMAT

(71) Applicant: SHARP KABUSHIKI KAISHA, Sakai City, Osaka (JP)

(72) Inventor: SACHIN G. DESHPANDE, Vancouver, WA (US)

(21) Appl. No.: 16/494,898

(22) PCT Filed: Jan. 31, 2018
(86) PCT No.: PCT/JP2018/003264

§ 371 Date: Sep. 17, 2019

Related U.S. Application Data
(60) Provisional application No. 62/473,609, filed on Mar. 20, 2017.

(51) Int. Cl. H04N 19/70; H04N 19/30; H04N 19/187

(52) U.S. Cl. CPC H04N 19/70; H04N 19/187; H04N 19/30

(57) ABSTRACT

A method of encapsulating data is disclosed. The method comprises: receiving coded video data, wherein coded video data includes multi-layer video presentation data; setting one or more parameter values associated with the coded video data; and encapsulating the coded video data in a data structure.

### TECHNICAL FIELD

This disclosure relates to video coding and more particularly to techniques for signaling scalable video data.

### BACKGROUND ART

Digital video capabilities can be incorporated into a wide range of devices, including digital televisions, laptop or desktop computers, tablet computers, digital recording devices, digital media players, video gaming devices, cellular telephones, including so-called smartphones, medical imaging devices, and the like. Digital video may be coded according to a video coding standard. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265 April 2015, which is incorporated by reference, and referred to herein as ITU-T H.265. Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Intra prediction coding techniques (e.g., intra-picture (spatial)) and inter prediction techniques (i.e., inter-picture (temporal)) may be used to generate difference values between a unit of video data to be coded and a reference unit of video data. The difference values may be referred to as residual data. Residual data may be coded as quantized transform coefficients. Syntax elements may relate residual data and a reference coding unit (e.g., intra-prediction mode indices, motion vectors, and block vectors). Residual data and syntax elements may be entropy coded. Entropy encoded residual data and syntax elements may be included in a compliant bitstream. Compliant bitstreams and associated metadata may be encapsulated according to a data structure. For example, one or more compliant bitstreams forming a video presentation and metadata associated therewith may be encapsulated according to a file format. Current techniques for encapsulating video data may be less than ideal.

### SUMMARY OF INVENTION

In one example, a method of encapsulating data comprises receiving coded video data, wherein coded video data includes multi-layer video presentation data, setting one or more parameter values associated with the coded video data, and encapsulating the coded video data in a data structure.

### BRIEF DESCRIPTION OF DRAWINGS

FIG. 1 is a block diagram illustrating an example of a system that may be configured to encode and decode video data according to one or more techniques of this disclosure.

FIG. 2 is a conceptual diagram illustrating coded video data and corresponding data structures according to one or more techniques of this disclosure.

FIG. 3 is a conceptual diagram illustrating a data structure encapsulating coded video data and corresponding metadata according to one or more techniques of this disclosure.

FIG. 4 is a conceptual drawing illustrating an example of components that may be included in an implementation of a system that may be configured to encode and decode video data according to one or more techniques of this disclosure.

FIG. 5 is a block diagram illustrating an example of a video encoder that may be configured to encode video data according to one or more techniques of this disclosure.

FIG. 6 is a block diagram illustrating an example of a video decoder that may be configured to decode video data according to one or more techniques of this disclosure.

### DESCRIPTION OF EMBODIMENTS

In general, this disclosure describes various techniques for coding video data. In particular, this disclosure describes techniques for encapsulating and decapsulating video data according to a data structure. Example data structures, described herein may be particularly useful for enabling efficient transmission of scalable video presentations to a diverse range of devices utilizing various data communication techniques. It should be noted that although techniques of this disclosure are described with respect to ITU-T H.264, and ITU-T H.265, the techniques of this disclosure may generally applicable to video coding. For example, the coding techniques described herein may be incorporated into video coding systems (including video coding systems based on future video coding standards) including block structures, intra prediction techniques, inter prediction techniques, transform techniques, filtering techniques, and/or entropy coding techniques other than those included in ITU-T H.265. Thus, reference to ITU-T H.264, and/or ITU-T H.265, is for descriptive purposes and should not be construed to limit the scope of the techniques described herein. For example, the techniques described herein may enable efficient transmission of scalable video presentations for video presentations including video data coded according to other video coding techniques, including, e.g., video coding techniques currently under de-velopment. Further, it should be noted that incorporation by reference of documents herein is for descriptive purposes and should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

In one example, a device comprises one or more processors configured to receive coded video data, wherein coded video data includes multi-layer video presentation data, set one or more parameter values associated with the coded video data, and encapsulate the coded video data in a data structure.

In one example, a non-transitory computer-readable storage medium comprises instructions stored thereon that, when executed, cause one or more processors of a device to receive coded video data, wherein coded video data includes multi-layer video presentation data, set one or more parameter values associated with the coded video data, and encapsulate the coded video data in a data structure.

In one example, an apparatus comprises means for receiving coded video data, wherein coded video data includes multi-layer video presentation data, setting one or more parameter values associated with the coded video data, and encapsulating the coded video data in a data structure.

In one example, a method of decapsulating data comprises receiving a data structure encapsulated according to one or more of the techniques described herein, and decapsulating the data structure.

In one example, a device comprises one or more processors configured to receive a data structure encapsulated according to one or more of the techniques described herein, and decapsulate the data structure.

In one example, a non-transitory computer-readable storage medium comprises instructions stored thereon that, when executed, cause one or more processors of a device to receive a data structure encapsulated according to one or more of the techniques described herein, and decapsulate the data structure.

In one example, an apparatus comprises means for receiving a data structure encapsulated according to one or more of the techniques described herein, and decapsulating the data structure.

The details of one or more examples are set forth in the accompanying drawings and the description below. Other features, objects, and advantages will be apparent from the description and drawings, and from the claims.

Video content typically includes video sequences comprised of a series of frames. A series of frames may also be referred to as a group of pictures (GOP). Each video frame or picture may include a plurality of slices or tiles, where a slice or tile includes a plurality of video blocks. A video block may be defined as the largest array of pixel values (also referred to as samples) that may be predictively coded. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. As used herein, the term video block may generally refer to an area of a picture or may more specifically refer to the largest array of pixel values that may be predictively coded, sub-divisions thereof, and/or corresponding structures.

In ITU-T H.265, the CTBs of a CTU may be partitioned into Coding Blocks (CB) according to a corresponding quadtree block structure. According to ITU-T H.265, one luma CB together with two corresponding chroma CBs and associated syntax elements are referred to as a coding unit (CU). A CU is associated with a prediction unit (PU) structure defining one or more prediction units (PU) for the CU, where a PU is associated with corresponding reference samples. That is, in ITU-T H.265 the decision to code a picture area using intra prediction or inter prediction is made at the CU level and for a CU one or more predictions corresponding to intra prediction or inter prediction may be used to generate reference samples for CBs of the CU. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples. Residual data may include respective arrays of difference values corresponding to each component of video data (e.g., luma (Y) and chroma (Cb and Cr)). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, CUs may be further sub-divided into Transform Units (TUs). That is, an array of pixel difference values may be sub-divided for purposes of generating transform coefficients (e.g., four 8×8 transforms may be applied to a 16×16 array of residual values corresponding to a 16×16 luma CB), such sub-divisions may be referred to as Transform Blocks (TBs). Transform coefficients may be quantized according to a quantization parameter (QP). Quantized transform coefficients (which may be referred to as level values) may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements, such as, a syntax element indicating a prediction mode, may also be entropy coded. Entropy encoded quantized transform coefficients and corresponding entropy encoded syntax elements may form a compliant bitstream that can be used to reproduce video data. A binarization process may be performed on syntax elements as part of an entropy coding process. Binarization refers to the process of converting a syntax value into a series of one or more bits. These bits may be referred to as “bins.”

In ITU-T H.265, a coded video sequence may be encapsulated (or structured) as a sequence of access units, where each access unit include video data structured as network abstraction layer (NAL) units. In ITU-T H.265, access units and NAL units are defined as:

network abstraction layer (NAL) unit: A syntax structure containing an indication of the type of data to follow and bytes containing that data in the form of an raw byte sequence payload (RBSP) interspersed as necessary with emulation prevention bytes.

access unit: A set of NAL units that are associated with each other according to a specified classification rule, are consecutive in decoding order, and contain exactly one coded picture with nuh_layer_id equal to 0.

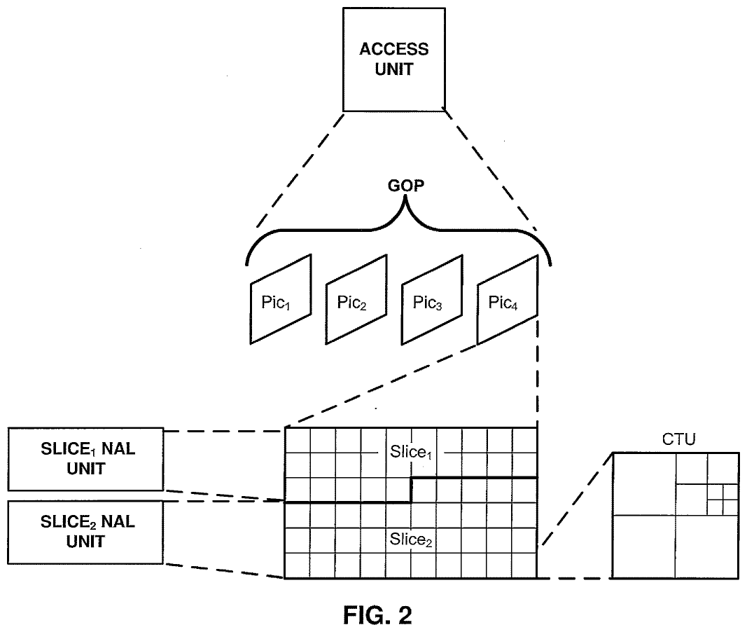

FIG. 2 is a conceptual diagram illustrating an example of a coded group of pictures structured according to an access unit including NAL units. In the example illustrated in FIG. 2, each slice of video data included in the group pictures is associated with a NAL unit. Further, in ITU-T H.265 each of a video sequence, a GOP, a picture, a slice, and CTU may be associated with metadata that describes video coding properties. ITU-T H.265 defines parameters sets that may be used to describe video data and/or video coding properties. In ITU-T H.265, parameter sets may be encapsulated as a special type of NAL unit or may be signaled as a message. NAL units including coded video data (e.g., a slice) may be referred to as VCL (Video Coding Layer) NAL units and NAL units including metadata (e.g., parameter sets) may be referred to as non-VCL NAL units. ITU-T H.265 provides the following types of defined parameter sets:

video parameter set (VPS): A syntax structure containing syntax elements that apply to zero or more entire coded video sequences (CVSs) as determined by the content of a syntax element found in the SPS referred to by a syntax element found in the PPS referred to by a syntax element found in each slice segment header.

sequence parameter set (SPS): A syntax structure containing syntax elements that apply to zero or more entire CVSs as determined by the content of a syntax element found in the PPS referred to by a syntax element found in each slice segment header.

picture parameter set (PPS): A syntax structure containing syntax elements that apply to zero or more entire coded pictures as determined by a syntax element found in each slice segment header.

Further, ITU-T H.265 supports multi-layer extensions, including format range extensions (RExt), scalability (SHVC), multi-view (MV-HEVC), and 3-D (3D-HEVC). In some cases, multi-layer extensions supported by ITU-T H.265 may be referred to as layered-HEVC (L-HEVC) or a multi-layer HEVC presentations. Multi-layer extensions enable a video presentation to include a base layer and one or more additional enhancement layers. For example, a base layer may enable a video presentation having a basic level of quality (e.g., High Definition rendering) to be presented and an enhancement layer may enable a video presentation having an enhanced level of quality (e.g., an Ultra High Definition rendering) to be presented. In ITU-T H.265, an enhancement layer may be coded by referencing a base layer. That is, for example, a picture in an enhancement layer may be coded (e.g., using inter prediction techniques) by referencing one or more pictures (including scaled versions thereof) in a base layer. It should be noted that in some cases, a base layer and an enhancement layer may be coded according to different video coding standards. For example, a base layer may be coded according to ITU-T H.264 and an enhancement layer may be coded according to ITU-T H.265. In ITU-T H.265, each NAL unit may include an identifier (nuh_layer_id) indicating a layer of video data the NAL unit is associated with. ITU-T H.265 defines nuh_layer_id as follows:

nuh_layer_id specifies the identifier of the layer to which a VCL (Video Coding Layer) NAL unit belongs or the identifier of a layer to which a non-VCL NAL unit applies.

Further, Annex F of ITU-T H.265 provides parameter sets and Visual Usability Information (VUI) that may be used to support L-HEVC and Annex H of ITU-T H.265 provides descriptions of how Scalable HEVC video may be coded (e.g., hypothetical reference decoder behavior and the like are described). For the sake of brevity, a complete description of Annex F and Annex H of ITU-T H.265 are not reproduced herein, however, Annex F and Annex H of ITU-T H.265 are incorporated by reference herein.

ITU-T H.265 includes the following defined syntax elements for profile, tier and level semantics:
general_profile_space specifies the context for the interpretation of general_profile_idc and general_profile_compatibility_flag[j] for all values of j in the range of 0 to 31, inclusive. The value of general_profile_space shall be equal to 0 in bitstreams conforming to this version of this Specification. Other values for general_profile_space are reserved for future use by ITU-T|ISO/IEC. Decoders shall ignore the CVS when general_profile_space is not equal to 0.
   general_tier_flag specifies the tier context for the interpretation of general_level_idc as specified in Annex A [of I-ITU H.265].
   general_profile_idc, when general_profile_space is equal to 0, indicates a profile to which the CVS conforms as specified in Annex A [of I-ITU H.265]. Bitstreams shall not contain values of general_profile_idc other than those specified in Annex A [of I-ITU H.265]. Other values of general_profile_idc are reserved for future use by ITU-T|ISO/IEC.
   general_progressive_source_flag and general_interlaced_source_flag are interpreted as follows:

If general_progressive_source_flag is equal to 1 and general_interlaced_source_flag is equal to 0, the source scan type of the pictures in the CVS should be interpreted as progressive only.

Otherwise, if general_progressive_source_flag is equal to 0 and general_interlaced_source_flag is equal to 1, the source scan type of the pictures in the CVS should be interpreted as interlaced only.

Otherwise, if general_progressive_source_flag is equal to 0 and general_interlaced_source_flag is equal to 0, the source scan type of the pictures in the CVS should be interpreted as unknown or unspecified.

Otherwise (general_progressive_source_flag is equal to 1 and general_interlaced_source_flag is equal to 1), the

source scan type of each picture in the CVS is indicated at the picture level using the syntax element source_scan_type in a picture timing SEI (Supplemental Enhancement Information) message.
general_non_packed_constraint_flag equal to 1 specifies that there are neither frame packing arrangement SEI messages nor segmented rectangular frame packing arrangement SEI messages present in the CVS. general_non_packed_constraint_flag equal to 0 indicates that there may or may not be one or more frame packing arrangement SEI messages or segmented rectangular frame packing arrangement SEI messages present in the CVS.
general_frame_only_constraint_flag equal to 1 specifies that field_seq_flag is equal to 0. general_frame_only_constraint_flag equal to 0 indicates that field_seq_flag may or may not be equal to 0
general_level_idc indicates a level to which the CVS conforms as specified in Annex A [of I-ITU H.265]. Bitstreams shall not contain values of general_level_idc other than those specified in Annex A [of I-ITU H.265]. Other values of general_level_idc are reserved for future use by ITU-T|ISO/IEC.
sub_layer_profile_present_flag[i] equal to 1, specifies that profile information is present in the profile_tier_level( ) syntax structure for the sub-layer representation with TemporalId equal to i. sub_layer_profile_present_flag[i] equal to 0 specifies that profile information is not present in the profile_tier_level( ) syntax structure for the sub-layer representation with TemporalId equal to i. When profilePresentFlag is equal to 0, sub_layer_profile_present_flag[i] shall be equal to 0.
sub_layer_level_present_flag[i] equal to 1 specifies that level information is present in the profile_tier_level( ) syntax structure for the sub-layer representation with TemporalId equal to i. sub_layer_level_present_flag[i] equal to 0 specifies that level information is not present in the profile_tier_level( ) syntax structure for the sub-layer representation with TemporalId equal to i

The VPS semantics in Annex F of ITU-T H.265 includes the following defined syntax elements:

vps_extension_flag equal to 0 specifies that no vps_extension( ) syntax structure is present in the VPS RBSP syntax structure. vps_extension_flag equal to 1 specifies that the vps_extension( ) syntax structure is present in the VPS RBSP syntax structure. When MaxLayersMinus 1 is greater than 0, vps_extension_flag shall be equal to 1.

Where vps_extension( ) syntax structure includes

vps_num_profile_tier_level_minus1 plus 1 specifies the number of profile_tier_level( ) syntax structures in the VPS. The value of vps_num_profile_tier_level_minus1 shall be in the range of 0 to 63, inclusive. When vps_max_layers_minus1 is greater than 0, the value of vps_num_profile_tier_level_minus1 shall be greater than or equal to 1.

vps_vui_present_flag equal to 1 specifies that the vps_vui( ) syntax structure is present in the VPS. vps_vui_present_flag equal to 0 specifies that the vps_vui( ) syntax structure is not present in the VPS.

Further, the VPS VUI field syntax in Annex F of ITU-T H.265 includes the following defined syntax elements:

pic_rate_present_vps_flag equal to 1 specifies that the syntax element pic_rate_present_flag[i][j] is present. pic_rate_present_vps_flag equal to 0 specifies that the syntax element pic_rate_present_flag[i][j] is not present. pic_rate_present_flag[i][j] equal to 1 specifies that picture rate information for the j-th subset of the i-th layer set is present. pic_rate_present_flag[i][j] equal to 0 specifies that picture rate information for the j-th subset of the i-th layer set is not present. When not present, the value of pic_rate_present_flag[i][j] is inferred to be equal to 0.

constant_pic_rate_idc[i][j] indicates whether the picture rate of the j-th subset of the i-th layer set is constant. In the following, a temporal segment tSeg is any set of two or more consecutive access units, in decoding order, of the j-th subset of the i-th layer set, auTotal(tSeg) is the number of access units in the temporal segment tSeg, t1(tSeg) is the removal time (in seconds) of the first access unit (in decoding order) of the temporal segment tSeg, t2(tSeg) is the removal time (in seconds) of the last access unit (in decoding order) of the temporal segment tSeg, and avgPicRate(tSeg) is the average picture rate in the temporal segment tSeg, and is specified as follows: avgPicRate(tSeg)=Round(auTotal(tSeg)*256÷ (t2(tSeg)−t1(tSeg))) If the j-th subset of the i-th layer set only contains one or two access units or the value of avgPicRate(tSeg) is constant over all the temporal segments, the picture rate is constant; otherwise, the picture rate is not constant.

constant_pic_rate_idc[i][j] equal to 0 indicates that the picture rate of the j-th subset of the i-th layer set is not constant.
constant_pic_rate_idc[i][j] equal to 1 indicates that the picture rate of the j-th subset of the i-th layer set is constant.
constant_pic_rate_idc[i][j] equal to 2 indicates that the picture rate of the j-th subset of the i-th layer set may or may not be constant. The value of constant_pic_rate_idc[i][j] shall be in the range of 0 to 2, inclusive.

Further, the VPS VUI field semantics in Annex F of ITU-T H.265 includes video_signal_info( ) which includes the following defined syntax elements: video_vps_format, video_full_range_vps_flag, colour_primaries_vps, transfer_characteristics_vps and matrix_coeffs_vps each of which may be used for inference of the values of the SPS VUI syntax elements video_format, video_full_range_flag, colour_primaries, transfer_characteristics, and matrix_coeffs, respectively, for each SPS that refers to the VPS.

The SPS semantics in Annex F of ITU-T H.265 includes the following defined syntax element:

vui_parameters_present_flag equal to 1 specifies that the vui_parameters( ) syntax structure as specified in Annex E is present. vui_parameters_present_flag equal to 0 specifies that the vui_parameters( ) syntax structure as specified in Annex E is not present.

The VUI parameters in in Annex E of ITU-T H.265 includes the following defined syntax elements:

aspect_ratio_info_present_flag equal to 1 specifies that aspect_ratio_idc is present. aspect_ratio_info_present_flag equal to 0 specifies that aspect_ratio_idc is not present.

aspect_ratio_idc specifies the value of the sample aspect ratio of the luma samples. Table E.1 [of ITU-T H.265] shows the meaning of the code. When aspect_ratio_idc indicates EXTENDED_SAR, the sample aspect ratio is represented by sar_width:sar_height. When the aspect_ratio_idc syntax element is not present, aspect_ratio_idc value is inferred to be equal to 0. Values of aspect_ratio_idc in the range of 17 to 254, inclusive, are reserved for future use by ITU-T|ISO/IEC and shall not be present in bitstreams conforming to this version of this Specification. Decoders shall interpret values of aspect_ratio_idc in the range of 17 to 254, inclusive, as equivalent to the value 0.

overscan_info_present_flag equal to 1 specifies that the overscan_appropriate_flag is present. When overscan_info_present_flag is equal to 0 or is not present, the preferred display method for the video signal is unspecified
video_full_range_flag indicates the black level and range of the luma and chroma signals as derived from E′Y, E′PB, and E′PR or E′R, E′G and E′B real-valued component signals.
When the video_full_range_flag syntax element is not present, the value of video_full_range_flag is inferred to be equal to 0.
colour_description_present_flag equal to 1 specifies that colour_primaries, transfer_characteristics and matrix_coeffs are present. colour_description_present_flag equal to 0 specifies that colour_primaries, transfer_characteristics and matrix_coeffs are not present.
colour_primaries indicates the chromaticity coordinates of the source primaries as specified in Table E.3 [of ITU-T H.265] in terms of the CIE 1931 definition of x and y as specified in ISO 11664-1.
transfer_characteristics indicates the opto-electronic transfer characteristic of the source picture as specified in Table E.4 [of ITU-T H.265] as a function of a linear optical intensity input Lc with a nominal real-valued range of 0 to 1.
matrix_coeffs describes the matrix coefficients used in deriving luma and chroma signals from the green, blue and red or Y, Z and X primaries, as specified in Table E.5[of ITU-T H.265]
chroma_loc_info_present_flag equal to 1 specifies that chroma_sample_loc_type_top_field and chroma_sample_loc_type_bottom_field are present. chroma_loc_info_present_flag equal to 0 specifies that chroma_sample_loc_type_top_field and chroma_sample_loc_type_bottom_field are not present. When chroma_format_idc is not equal to 1, chroma_loc_info_present_flag should be equal to 0
vui_timing_info_present_flag equal to 1 specifies that vui_num_units_in_tick, vui_time_scale,
vui_poc_proportional_to_timing_flag and vui_hrd_parameters_present_flag are present in the vui_parameters( ) syntax structure. vui_timing_info_present_flag equal to 0 specifies that vui_num_units_in_tick, vui_time_scale,
vui_poc_proportional_to_timing_flag and vui_hrd_parameters_present_flag are not present in the vui_parameters( ) syntax structure.
vui_num_units_in_tick is the number of time units of a clock operating at the frequency vui_time_scale Hz that corresponds to one increment (called a clock tick) of a clock tick counter. vui_num_units_in_tick shall be greater than 0. A clock tick, in units of seconds, is equal to the quotient of vui_num_units_in_tick divided by vui_time_scale. For example, when the picture rate of a video signal is 25 Hz, vui_time_scale may be equal to 27 000 000 and vui_num_units_in_tick may be equal to 1 080 000 and consequently a clock tick may be equal to 0.04 seconds. When vps_num_units_in_tick is present in the VPS referred to by the SPS, vui_num_units_in_tick, when present, shall be equal to vps_num_units_in_tick, and when not present, is inferred to be equal to vps_num_units_in_tick. vui_time_scale is the number of time units that pass in one second. For example, a time coordinate system that measures time using a 27 MHz clock has a vui_time_scale of 27 000 000. The value of vui_time_scale shall be greater than 0. When vps_time_scale is present in the VPS referred to by the SPS, vui_time_scale, when present, shall be equal to vps_time_scale, and when not present, is inferred to be equal to vps_time_scale.
vui_hrd_parameters_present_flag equal to 1 specifies that the syntax structure hrd_parameters( ) is present in the vui_parameters( ) syntax structure. vui_hrd_parameters_present_flag equal to 0 specifies that the syntax structure hrd_parameters( ) is not present in the vui_parameters( ) syntax structure.

Where hrd_parameters( ) include

fixed_pic_rate_general_flag[i] equal to 1 indicates that, when HighestTid is equal to i, the temporal distance between the HRD output times of consecutive pictures in output order is constrained as specified below. fixed_pic_rate_general_flag[i] equal to 0 indicates that this constraint may not apply. When fixed_pic_rate_general_flag[i] is not present, it is inferred to be equal to 0.

fixed_pic_rate_within_cvs_flag[i] equal to 1 indicates that, when HighestTid is equal to i, the temporal distance between the HRD output times of consecutive pictures in output order is constrained as specified below. fixed_pic_rate_within_cvs_flag[i] equal to 0 indicates that this constraint may not apply. When fixed_pic_rate_general_flag[i] is equal to 1, the value of fixed_pic_rate_within_cvs_flag[i] is inferred to be equal to 1.

Further, ITU-T H.265 supports picture cropping. That is, a picture may be coded according to picture size and output (e.g., for display) according to a cropped picture size. The General sequence parameter set RBSP semantics in clause 7 of ITU-T H.265 and the General sequence parameter set RBSP semantics in Annex F of ITU-T H.265 include the following defined syntax elements:

conformance_window_flag equal to 1 indicates that the conformance cropping window offset parameters follow next in the SPS. conformance_window_flag equal to 0 indicates that the conformance cropping window offset parameters (i.e., conf_win_left_offset, conf_win_right_offset, conf_win_top_offset and conf_win_bottom_offset) are not present. conf_win_left_offset, conf_win_right_offset, conf_win_top_offset and conf_win_bottom_offset specify the samples of the pictures in the CVS that are output from the decoding process, in terms of a rectangular region specified in picture coordinates for output. When conformance_window_flag is equal to 0, the values of conf_win_left_offset, conf_win_right_offset, conf_win_top_offset and conf_win_bottom_offset are inferred to be equal to 0.

The conformance cropping window contains the luma samples with horizontal picture coordinates from SubWidthC*conf_win_left_offset to pic_width_in_luma_samples−(SubWidthC*conf_win_right_offset+1) and vertical picture coordinates from SubHeightC*conf_win_top_offset to pic_height_in_luma_samples−(SubHeightC*conf_win_bottom_offset+1), inclusive.

The value of SubWidthC*(conf_win_left_offset+conf_win_right_offset) shall be less than

pic_width_in_luma_samples, and the value of SubHeightC*(conf_win_top_offset+conf_win_bottom_offset) shall be less than pic_height_in_luma_samples.

When ChromaArrayType is not equal to 0, the corresponding specified samples of the two chroma arrays are the samples having picture coordinates (x/SubWidthC, y/SubHeightC), where (x, y) are the picture coordinates of the specified luma samples.

NOTE 3—The conformance cropping window offset parameters are only applied at the output. All internal decoding processes are applied to the uncropped picture size.

Further, the Representation format syntax and in Annex F of ITU-T H.265 includes the following defined syntax elements:

conformance_window_vps_flag equal to 1 specifies that the syntax elements conf_win_vps_left_offset, conf_win_vps_right_offset, conf_win_vps_top_offset and conf_win_vps_bottom_offset follow next in the rep format( ) structure. con-formance_window_vps_flag equal to 0 specifies that the syntax elements conf_win_vps_left_offset, conf_win_vps_right_offset, conf_win_vps_top_offset and conf_win_vps_bottom_offset are not present.

conf_win_vps_left_offset, conf_win_vps_right_offset, conf_win_vps_top_offset and conf_win_vps_bottom_offset are used for inference of the values of the SPS syntax elements, conf_win_left_offset, conf_win_right_offset, conf_win_top_offset and conf_win_bottom_offset, respectively, for each SPS that refers to the VPS. When not present, the values of conf_win_vps_left_offset, conf_win_vps_right_offset, conf_win_vps_top_offset and conf_win_vps_bottom_offset are inferred to be equal to 0.

The value of SubWidthC*(conf_win_vps_left_offset+conf_win_vps_right_offset) shall be less than pic_width_vps_in_luma_samples and the value of SubHeightC*(conf_win_vps_top_offset+conf_win_vps_bottom_offset) shall be less than pic_height_vps_in_luma_samples

These Representation format syntax elements, conformance_window_vps_flag, conf_win_vps_left_offset, conf_win_vps_right_offset, conf_win_vps_top_offset and conf_win_vps_bottom_offset, may be included in video parameter set extension (vps_extension( )).

Thus, one more or properties and/or parameters of a multi-layer HEVC presentation may be signaled according to the semantics provided ITU-T H.265. It should be noted that ITU-T H.265 provides flexibility with respect to how and if properties and/or parameters may be signaled.

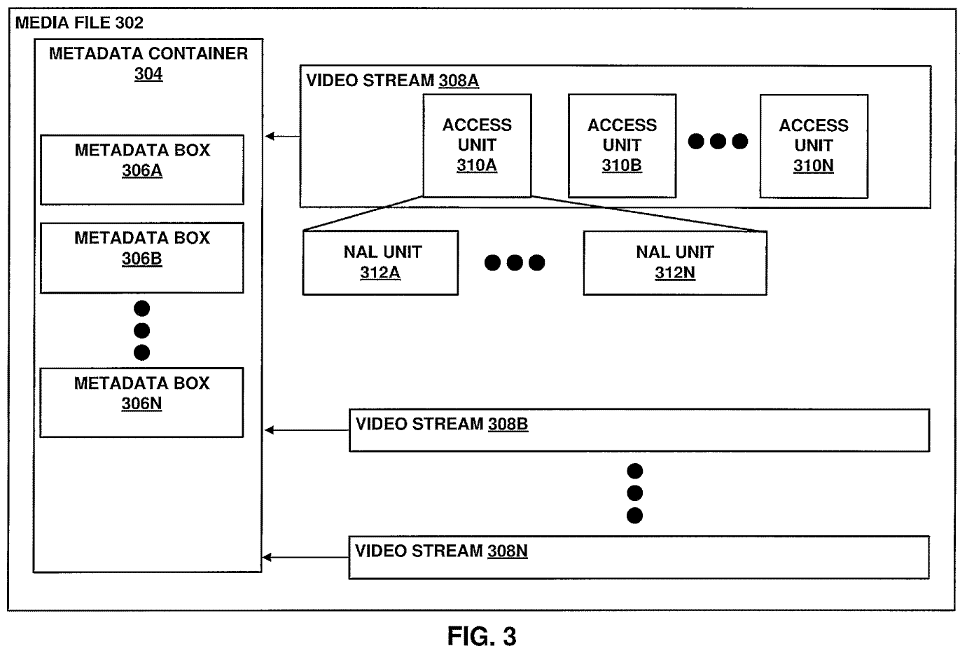

A multi-layered HEVC presentation may be encapsulated according to a data structure. ISO/IEC 14496-15, Third Edition, “Information technology—Coding of audio-visual objects—Carriage of NAL unit structured video in the ISO Base Media File Format,” (hereinafter “ISO-VIDEO”) which is incorporated by reference, describes a data structure for encapsulating multi-layer HEVC presentations. ISO-VIDEO specifies a storage format for streams of video that are structured as NAL Units (e.g., ITU-T H.264 and ITU-T H.265). FIG. 3 is a conceptual diagram illustrating a media file encapsulating coded video data and corresponding metadata. It should be noted that example media file 302 in FIG. 3 is intended to illustrate the logical relationship between coded video data and metadata. For the sake of brevity, a complete description of a data included in a media file is not provided (e.g., file headers, tables, box types, etc.).

In ISO/IEC 14496-15, aggregator, extractors, are defined as:

aggregator in-stream structure using a NAL unit header for grouping of NAL units belonging to the same sample.

extractors in-stream structure using a NAL unit header for extraction of data from other tracks

NOTE: Extractors contain instructions on how to extract data from other tracks. Logically an Extractor can be seen as a pointer to data. While reading a track containing Extractors, the Extractor is replaced by the data it is pointing to.

A sample may be all the data associated with a single timestamp.

In the example illustrated in FIG. 3, media file 302 includes video elementary streams 308A-308N that reference metadata container 304. As illustrated in FIG. 3, video streams 308A-308N including NAL units 312A-312N grouped into access units 310A-310N. As described above, NAL units may include VCL-NAL units and non-VCL units. As further illustrated in FIG. 3, metadata container 304 includes metadata boxes 306A-306B. It should be noted that in some cases, metadata boxes may be referred to as a metadata objects. In one example, metadata boxes 306A-306B may include parameter sets (e.g., one or more of the ITU-T H.265 parameter sets described above). Thus, parameter sets may be included in metadata boxes 306A-306B (which may be referred to as “out-of-band”) and/or video elementary streams (which may be referred to as “in-band”). It should be noted that in some examples, a video stream may be referred to as a video track. Further, it should be noted that a file format may define different types of configurations. For example, a file format may specify one or more box types. A file format configuration may be defined based on properties of video streams that may be included in an instance of the file format. For example, a box type may be defined based on one or more constraints applied to a video streams, e.g., a box type may require that each video stream include to have a certain number of specific types of NAL units within each access unit. Further, a box type may require one or more properties and/or parameters of a video presentation to be included in a metadata box. Table 1 provides a summary of configurations of video presentations specified in ISO-VIDEO.

TABLE 1

| sample | with | |
|---|---|---|
| entry | configuration | |
| name | records | Meaning |
| ′hvc′ | HEVC | A plain HEVC track without NAL units |
| or | Configuration | with nuh_layer_id greater than 0; |
| ′hev1′ | Only | Extractors and aggregators shall not be |
| | | present. |
| ′hvc1′ | HEVC | An L-HEVC track with both NAL units with |
| or | and | nuh_layer_id equal to 0 and NAL units with |
| ′hev1′ | L-HEVC | nuh_layer_id greater than 0; Extractors and |
| | Configurations | aggregators may be present; Extractors |
| | | shall not reference NAL units with |
| | | nuh_layer_id equal to 0; Aggregators shall |
| | | not contain but may reference NAL units |
| | | with nuh_layer_id equal to 0. |
| ′hvc2′ | HEVC | A plain HEVC track without NAL units |
| or | Configuration | with nuh_layer_id greater than 0; |
| ′hev2′ | Only | Extractors may be present and used to |
| | | reference NAL units; Aggregators may be |
| | | present to contain and reference NAL units. |
| ′hvc2′ | HEVC | An L-HEVC track with both NAL units with |
| or | and | nuh_layer_id equal to 0 and NAL units with |
| ′hev2′ | L-HEVC | nuh_layer_id greater than 0; Extractors and |
| | Configurations | aggregators may be present; Extractors may |
| | | reference any NAL units; Aggregators may |
| | | both contain and reference any NAL units. |
| ′lhv1′, | L-HEVC | An L-HEVC track without NAL units with |
| ′lhe1′ | Configuration | nuh_layer_id equal to 0 and where the track |
| | Only | contents are to be a part of an L-HEVC bit |
| | | stream; Extractors may be present and used |
| | | to reference NAL units; Aggregators may be |
| | | present to contain and reference NAL units. |

Thus, as illustrated in Table 1, ISO-VIDEO includes defined configurations that may support base HEVC presentations (without extensions) and/or HEVC presentations including multi-layer extensions Further, ISO-VIDEO provides that an L-HEVC stream can be placed in tracks in a number of ways, among which are the following: all the layers in one track; each layer in its own track; a hybrid way: one track containing all layers, and one or more single-layer tracks; the expected operating points each in a track (e.g. the HEVC base, a stereo pair, a multiview scene).

Further, ISO-VIDEO provides that when an L-HEVC bitstream is represented by multiple tracks and a player uses an operating point for which the layers are stored in multiple tracks, the player must reconstruct L-HEVC access units before passing them to the L-HEVC decoder. In ISO-VIDEO, an L-HEVC operating point may be ex-plicitly represented by a track, i.e., each sample in the track contains an access unit, where some or all NAL units of the access unit may be contained in or referred to by extractors and aggregators. In ISO-VIDEO, the storage of L-HEVC bitstreams is supported by structures such as the sample entry, Operating Points Information (‘oinf’) sample group, and Layer Information (‘linf’) sample group. The structures within a sample entry provide information for the decoding or use of the samples, in this case coded video information, that are associated with that sample entry. The Operating Points Information sample group records information about operating points such as the layers and sub-layers that constitute the operating point, dependencies (if any) between them, the profile, level, and tier parameter of the operating point, and other such operating point relevant information. The layer information sample group lists all the layers and sub-layers carried in the samples of the track. The information in these sample groups, combined with using track references to find tracks, is sufficient for a reader to choose an operating point in accordance with its capabilities, identify the tracks that contain the relevant layers and sub-layers needed to decode the chosen operating point, and efficiently extract them.

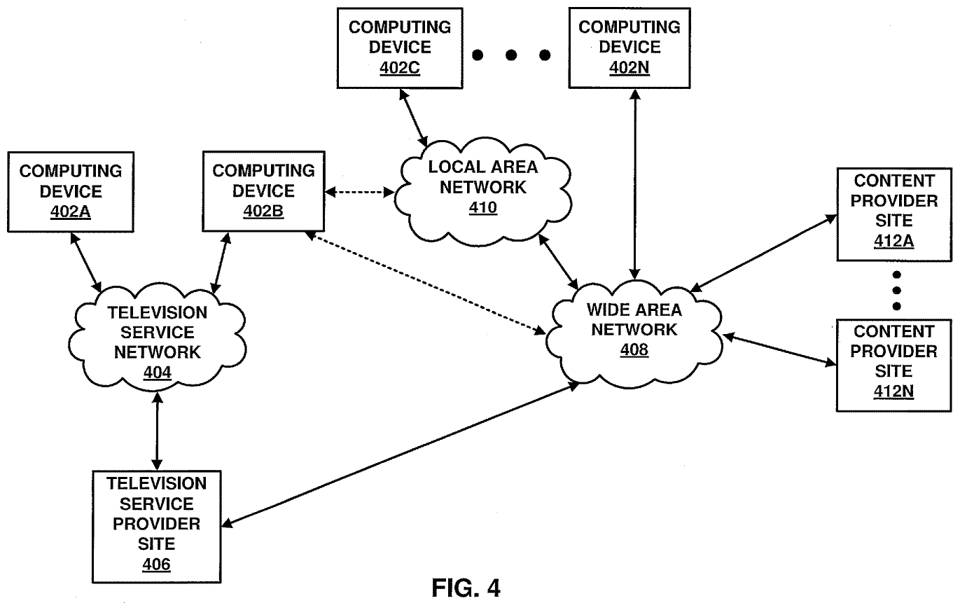

Common Media Application Format (CMAF), which is described in K. Hughes, D. Singer, K. Kolarov, I. Sodagar, “Common Media Application Format for Segmented Media-CMAF,” May 2016, which is incorporated by reference herein, defines a Media Application Format which is intended to be optimized for large scale delivery of a single encrypted, adaptable multimedia presentation to a wide range of devices which may be compatible with a variety of adaptive streaming, broadcast, download, and storage delivery techniques. FIG. 4, which is described in further detail below, includes a system including a wide range of devices which may be compatible with a variety of adaptive streaming, broadcast, download, and storage delivery techniques. It should be noted that CMAF currently does not support multi-layer HEVC. The techniques described herein may be used in order to provide an efficient manner for an CMAF based file format may support multi-layer HEVC.

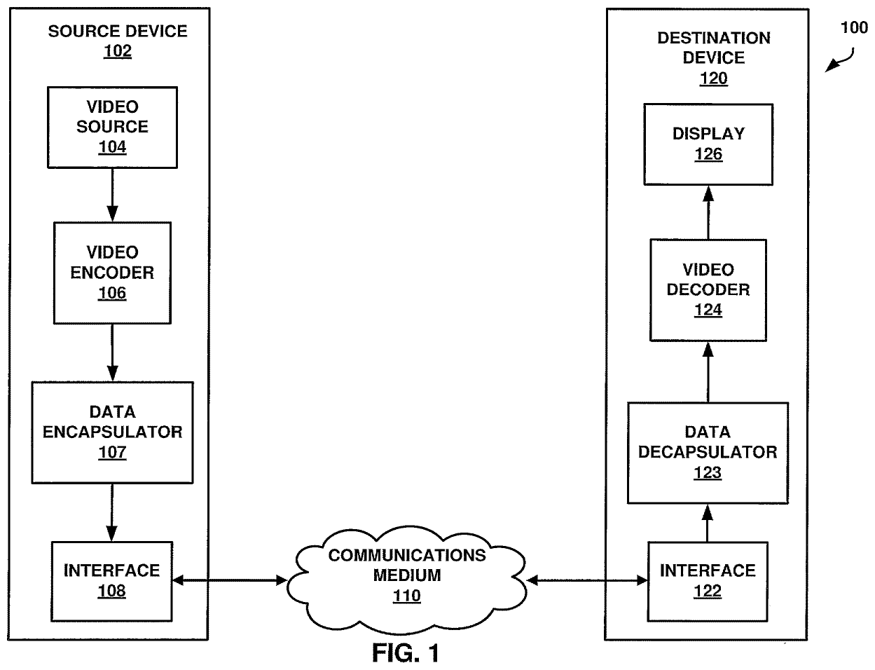

FIG. 1 is a block diagram illustrating an example of a system that may be configured to code (i.e., encode and/or decode) video data according to one or more techniques of this disclosure. System 100 represents an example of a system that may encapsulate video data according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include, for example, set top boxes, digital video recorders, televisions, desktop, laptop or tablet computers, gaming consoles, medical imagining devices, and mobile devices, including, for example, smartphones, cellular telephones, personal gaming devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

FIG. 4 is a conceptual drawing illustrating an example of components that may be included in an implementation of system 100. In the example implementation illustrated in FIG. 4, system 100 includes one or more computing devices 402A-402N, television service network 404, television service provider site 406, wide area network 408, local area network 410, and one or more content provider sites 412A-412N. The implementation illustrated in FIG. 4 represents an example of a system that may be configured to allow digital media content, such as, for example, a movie, a live sporting event, etc., and data and applications and media presentations associated therewith to be distributed to and accessed by a plurality of computing devices, such as computing devices 402A-402N. In the example illustrated in FIG. 4, computing devices 402A-402N may include any device configured to receive data from one or more of television service network 404, wide area network 408, and/or local area network 410. For example, computing devices 402A-402N may be equipped for wired and/or wireless communications and may be configured to receive services through one or more data channels and may include televisions, including so-called smart televisions, set top boxes, and digital video recorders. Further, computing devices 402A-402N may include desktop, laptop, or tablet computers, gaming consoles, mobile devices, including, for example, “smart” phones, cellular telephones, and personal gaming devices.

Television service network 404 is an example of a network configured to enable digital media content, which may include television services, to be distributed. For example, television service network 404 may include public over-the-air television networks, public or subscription-based satellite television service provider networks, and public or subscription-based cable television provider networks and/or over the top or Internet service providers. It should be noted that although in some examples television service network 404 may primarily be used to enable television services to be provided, television service network 404 may also enable other types of data and services to be provided according to any combination of the telecommunication protocols described herein. Further, it should be noted that in some examples, television service network 404 may enable two-way communications between television service provider site 406 and one or more of computing devices 402A-402N. Television service network 404 may comprise any combination of wireless and/or wired communication media. Television service network 404 may include coaxial cables, fiber optic cables, twisted pair cables, wireless transmitters and receivers, routers, switches, repeaters, base stations, or any other equipment that may be useful to facilitate communications between various devices and sites. Television service network 404 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 4, television service provider site 406 may be configured to distribute television service via television service network 404. For example, television service provider site 406 may include one or more broadcast stations, a cable television provider, or a satellite television provider, or an Internet-based television provider. For example, television service provider site 406 may be configured to receive a transmission including television programming through a satellite uplink/downlink. Further, as illustrated in FIG. 4, television service provider site 406 may be in communication with wide area network 408 and may be configured to receive data from content provider sites 412A-412N. It should be noted that in some examples, television service provider site 406 may include a television studio and content may originate therefrom.

Wide area network 408 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3rd Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 408 may comprise any combination of wireless and/or wired communication media. Wide area network 480 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 408 may include the Internet. Local area network 410 may include a packet based network and operate according to a combination of one or more telecommunication protocols. Local area network 410 may be distinguished from wide area network 408 based on levels of access and/or physical infrastructure. For example, local area network 410 may include a secure home network.

Referring again to FIG. 4, content provider sites 412A-412N represent examples of sites that may provide multimedia content to television service provider site 406 and/or computing devices 402A-402N. For example, a content provider site may include a studio having one or more studio content servers configured to provide multimedia files and/or streams to television service provider site 406. In one example, content provider sites 412A-412N may be configured to provide multimedia content using the IP suite. For example, a content provider site may be configured to provide multimedia content to a receiver device according to Real Time Streaming Protocol (RTSP), HTTP, or the like. Further, content provider sites 412A-412N may be configured to provide data, including hypertext based content, and the like, to one or more of receiver devices computing devices 402A-402N and/or television service provider site 406 through wide area network 408. Content provider sites 412A-412N may include one or more web servers. Data provided by data provider site 412A-412N may be defined according to data formats, such as, for example, HTML, Dynamic HTML, XML, and JSON.

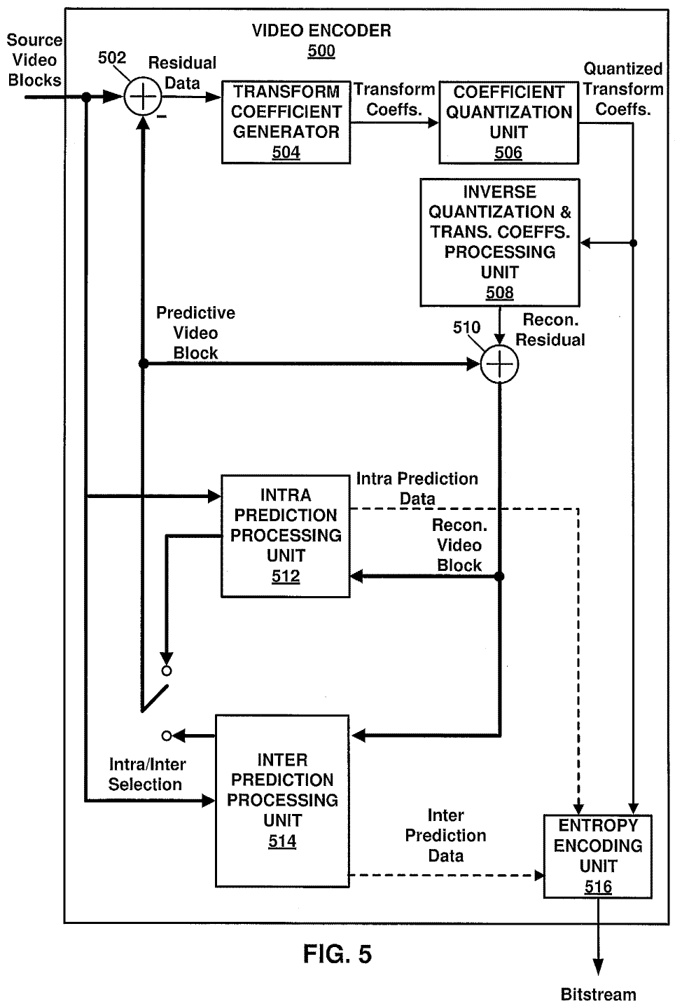

Referring again to FIG. 1, source device 102 includes video source 104, video encoder 106, data encapsulator 107, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream video encoder 106 may compress video data. Compression may be lossy (discernible or indiscernible to a viewer) or lossless. FIG. 5 is a block diagram illustrating an example of video encoder 500 that may implement the techniques for encoding video data described herein. It should be noted that although example video encoder 500 is illustrated as having distinct functional blocks, such an illustration is for descriptive purposes and does not limit video encoder 500 and/or sub-components thereof to a particular hardware or software architecture. Functions of video encoder 500 may be realized using any combination of hardware, firmware, and/or software implementations.

Video encoder 500 may perform intra prediction coding and inter prediction coding of picture areas, and, as such, may be referred to as a hybrid video encoder. In the example illustrated in FIG. 5, video encoder 500 receives source video blocks. In some examples, source video blocks may include areas of picture that has been divided according to a coding structure. For example, source video data may include macroblocks, CTUs, CBs, sub-divisions thereof, and/or another equivalent coding unit. In some examples, video encoder 500 may be configured to perform additional sub-divisions of source video blocks. It should be noted that the techniques described herein are generally applicable to video coding, regardless of how source video data is partitioned prior to and/or during encoding. In the example illustrated in FIG. 5, video encoder 500 includes summer 502, transform coefficient generator 504, coefficient quantization unit 506, inverse quantization and transform coefficient processing unit 508, summer 510, intra prediction processing unit 512, inter prediction processing unit 514, and entropy encoding unit 516. As illustrated in FIG. 5, video encoder 500 receives source video blocks and outputs a bitstream.

In the example illustrated in FIG. 5, video encoder 500 may generate residual data by subtracting a predictive video block from a source video block. The selection of a predictive video block is described in detail below. Summer 502 represents a component configured to perform this subtraction operation. In one example, the subtraction of video blocks occurs in the pixel domain. Transform coefficient generator 504 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 504 may be configured to perform any and all combinations of the transforms included in the family of discrete trigonometric transforms, including ap-proximations thereof. Transform coefficient generator 504 may output transform coefficients to coefficient quantization unit 506. Coefficient quantization unit 506 may be configured to perform quantization of the transform coefficients. The quantization process may reduce the bit depth associated with some or all of the coefficients. The degree of quantization may alter the rate-distortion (i.e., bit-rate vs. quality of video) of encoded video data. The degree of quantization may be modified by adjusting a quantization parameter (QP). A quantization parameter may be determined based on slice level values and/or CU level values (e.g., CU delta QP values). QP data may include any data used to determine a QP for quantizing a particular set of transform coefficients. As illustrated in FIG. 5, quantized transform coefficients (which may be referred to as level values) are output to inverse quantization and transform coefficient processing unit 508. Inverse quantization and transform coefficient processing unit 508 may be configured to apply an inverse quantization and an inverse transformation to generate reconstructed residual data. As illustrated in FIG. 5, at summer 510, reconstructed residual data may be added to a predictive video block. In this manner, an encoded video block may be reconstructed and the resulting reconstructed video block may be used to evaluate the encoding quality for a given prediction, transformation, and/or quantization. Video encoder 500 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

Referring again to FIG. 5, intra prediction processing unit 512 may be configured to select an intra prediction mode for a video block to be coded. Intra prediction processing unit 512 may be configured to evaluate a frame and determine an intra prediction mode to use to encode a current block. As described above, possible intra prediction modes may include planar prediction modes, DC prediction modes, and angular prediction modes. Further, it should be noted that in some examples, a prediction mode for a chroma component may be inferred from a prediction mode for a luma prediction mode. Intra prediction processing unit 512 may select an intra prediction mode after performing one or more coding passes. Further, in one example, intra prediction processing unit 512 may select a prediction mode based on a rate-distortion analysis. As illustrated in FIG. 5, intra prediction processing unit 512 outputs intra prediction data (e.g., syntax elements) to entropy encoding unit 516 and transform coefficient generator 504. As described above, a transform performed on residual data may be mode dependent (e.g., a secondary transform matrix may be determined based on a predication mode).

Referring again to FIG. 5, inter prediction processing unit 514 may be configured to perform inter prediction coding for a current video block. Inter prediction processing unit 514 may be configured to receive source video blocks and calculate a motion vector for PUs of a video block. A motion vector may indicate the displacement of a PU of a video block within a current video frame relative to a predictive block within a reference frame. Inter prediction coding may use one or more reference pictures. Further, motion prediction may be uni-predictive (use one motion vector) or bi-predictive (use two motion vectors). Inter prediction processing unit 514 may be configured to select a predictive block by calculating a pixel difference determined by, for example, sum of absolute difference (SAD), sum of square difference (SSD), or other difference metrics. As described above, a motion vector may be determined and specified according to motion vector prediction. Inter prediction processing unit 514 may be configured to perform motion vector prediction, as described above. Inter prediction processing unit 514 may be configured to generate a predictive block using the motion prediction data. For example, inter prediction processing unit 514 may locate a predictive video block within a frame buffer (not shown in FIG. 5). It should be noted that inter prediction processing unit 514 may further be configured to apply one or more interpolation filters to a reconstructed residual block to calculate sub-integer pixel values for use in motion estimation. Inter prediction processing unit 514 may output motion prediction data for a calculated motion vector to entropy encoding unit 516.

Referring again to FIG. 5, entropy encoding unit 518 receives quantized transform coefficients and predictive syntax data (i.e., intra prediction data and motion prediction data). It should be noted that in some examples, coefficient quantization unit 506 may perform a scan of a matrix including quantized transform coefficients before the coefficients are output to entropy encoding unit 518. In other examples, entropy encoding unit 518 may perform a scan. Entropy encoding unit 518 may be configured to perform entropy encoding according to one or more of the techniques described herein. Entropy encoding unit 518 may be configured to output a compliant bitstream, i.e., a bitstream that a video decoder can receive and reproduce video data therefrom. In this manner, video encoder 500 represents an example of a device configured to generate encoded video data according to one or more techniques of this disclose. In one example, video encoder 500 may generate encoded video data that may be used for a multi-layer HEVC presentation.

Referring again to FIG. 1, data encapsulator 107 may receive a compliant bitstream and encapsulate a compliant bit stream according to a file format. In one example, data encapsulator 107 may receive compliant bitstreams corresponding to any of the HEVC tracks described above with respect to Table 1. Further, data encapsulator 107 may receive compliant bitstreams corresponding to a plain HEVC track and output a file as specified in CMAF. As described above, CMAF currently does not support multi-layer HEVC. In one example, data encapsulator 107 may be configured to receive compliant bitstreams corresponding to multi-layer HEVC tracks and output a file based on CMAF. That is, data encapsulator 107 may receive compliant bitstreams and output a file that generally conforms to ITU H.265, ISO-VIDEO, and/or CMAF, but additionally enables support for multi-layer HEVC in a CMAF type file. It should be noted that a file generated by data encapsulator 107 may additionally conform to one or more of the constraints provide below. It should be noted that the one or more constraints provided below may enable efficient rendering of a multimedia presentation by a device receiving a file.

In one example, video tracks included in a file generated by data encapsulator 107 may comply with section 9 of ISO-VIDEO, where the base layer (if coded using HEVC specification) may be stored as described in section 9.4 of ISO-VIDEO. In one example, video tracks included in a file generated by data encapsulator 107 may conform to sample entry ‘hvc1’, or ‘hev1’, or ‘hvc2’, or ‘hev2’ as defined above in Table 1. In one example, a file generated by data encapsulator 107 may include an HEVCDecoderConfigurationRecord and a LHEVCDecoderConfigurationRecord, where the constraints in 9.4.1.3 of CMAF may apply to the HEVCDecoderConfigurationRecord and apply to HEVC compatible base layer. In one example, constraints in 9.4.1.3 of CMAF regarding inclusion of SEI messages, use and passing of SEI messages by an CMAF player may also apply to LHEVCDecoderConfigurationRecord and apply to enhancement layers. In this manner, data encapsulator 107 may be configured such that a base layer in a multi-layer HEVC presentation is encapsulated in manner that conforms with CMAF.

In one example, a file generated by data encapsulator 107 may have a requirement that the video profile illustrated in Table 2 applies to all scalable HEVC elementary streams included in the file.

TABLE 2

| | | | | | Frame | |
|---|---|---|---|---|---|---|
| Media | | | | Bitrate | Sz | Fillrate |
| Profile | Codec | Profile | Level | Mbps | Samples | Samples/s |
| SHV10 | Scalable | Scalable | 5.2 | 60 | 8 912 | 1 069 |
| | HEVC | Main10 | | | 896 | 547 520 |
| | | Main | | | | |
| | | Tier | | | | |
| | | 10-bit | | | | |

| | | Max | Max | Max Fr | |
|---|---|---|---|---|---|
| Color | | Height | Width | Rate | File |
| Coding | EOTF | Samples | Samples | @maxSize | Brand |
| BT- | BT- | 2160 | 3840 | 128 | ‘cus1’ |
| 709, | 1886 | | | | |
| 2020 | | | | | |

In this case a Media profile name, e.g. ‘SHV10’ and a new file brand e.g., ‘cus1’ may be defined for such a new media profile. The above media profile (SHV10) is an example and other such similar more than one media profiles may be defined to use scalable HEVC

In one example, a file generated by data encapsulator 107 may require all pictures included in a video stream to be encoded as coded frames and not be encoded as coded fields. In one example, a file generated by data encapsulator 107 may require the maximum bitrate of an HEVC elementary streams to be calculated by implementation of the buffer and timing model defined in I-ITU H.265 clause F.13. In one example, a file generated by encapsulator 107 may require sample durations stored in an ISO Media Track Run Box to determine the frame rate of a Track. In this case inclusion of frame rate—also called picture rate—related parameters described below in H.265 parameter sets are useful in knowing the frame rate/picture rate of the underlying video elementary stream.

As described above, one more or properties and/or parameters of a multi-layer HEVC presentation may be signaled according to the semantics provided in ITU-T H.265 and as further provided above, ITU-T H.265 provides flexibility with respect to how and if properties and/or parameters may be signaled. In one example, video data included in a file generated by data encapsulator 107 may conform to Annex F and Annex H of ITU-T H.265 while conforming to one or more of the example constraints provided in Table 3.

TABLE 3

| HEVC | |
|---|---|
| Data | |
| Structure | Constraints |
| Video | The following fields SHALL have values set as |
| Parameter | follows for each |
| Sets | profile_tier_level( ) structure in VPS: |
| (VPS) | general_progressive_source_flag SHALL be set to 1 |
| | general_frame_only_constraint_flag SHALL be set |
| | to 1 |
| | general_interlaced_source_flag SHALL be set to 0 |
| | general_non_packed_constraint_flag SHALL be set |
| | to 0 |
| | OR ALTERNATIVELY |
| | general_non_packed_constraint_flag SHALL be set |
| | to 1 |
| | vps_extension_flag SHALL be set to 1 |
| | vps_vui_present_flag SHALL be set to 1 |
| | The condition of the following fields for each |
| | profile_tier_level( ) structure in VPS SHALL |
| | NOT change throughout an Scalable |
| | HEVC elementary stream: |
| | general_profile_space |
| | general_profile_idc |
| | general_tier_flag |
| | general_level_idc |
| | The value of sub_layer_level_present_flag[ 0 ] shall be |
| | equal to 1 only when the value of |
| | sub_layer_level_idc[ 0 ] |
| | is different than the |
| | value of general_level_idc. |
| VPS | pic_rate_present_vps_flag SHALL be set equal to 1, |
| Visual | pic_rate_present_flag[ i ][ j ]SHALL be set equal to |
| Usability | 1 and |
| Information | constant_pic_rate_idc[ i ][ j ] SHALL be set equal to |
| (VUI) | 1 for all i, for j equal to |
| Fields | MaxSubLayersInLayerSetMinus1[ i ]; |
| | OR ALTERNATIVELY |
| | constant_pic_rate_idc[ i ][ j ]SHALL be set equal to |
| | 1 for all i, for all j. |
| | The values of the following fields in each |
| | video_signal_info( ) in VPS VUI SHALL NOT change |
| | throughout a CMAF Track and Switching Set: |
| | vps_video_format |
| | video_full_range_vps_flag |
| | colour_primaries_vps |
| | transfer_characteristics_vps |
| | matrix_coeffs_vps |
| Sequence | The following fields SHALL have pre-determined |
| Parameter | values as follows: |
| Sets | general_progressive_source_flag SHALL be set to 1 |
| (SPS) | general_frame_only_constraint_flag SHALL be set |
| | to 1 |
| | general_interlaced_source_flag SHALL be set to 0 |
| | general_non_packed_constraint_flag SHALL be set |
| | to 0 |
| | OR ALTERNATIVELY |
| | general_non_packed_constraint_flag SHALL |
| | be set to 1 |
| | vui_parameters_present_flag SHALL be set to 1 |
| | vui_timing_info_present_flag SHALL be set to 1, |
| | vui_hrd_parameters_present_flag in SHALL be set |
| | to 1, and fixed_pic_rate_general_flag[ i ] shall be |
| | set equal to 1 or fixed_pic_rate_within_cvs_flag |
| | [ maxNumSubLayersMinusl ]shall be set equal to |
| | 1. |
| | OR |
| | vui_timing_info_present_flag SHALL be set to 1, |
| | vui_hrd_parameters_present_flag in SHALL be set |
| | to 1, and fixed_pic_rate_general_flag[ i ] shall be set |
| | equal to 1 or fixed_pic_rate_within_cvs_flag [ i ] |
| | shall be set equal to 1 for all values of i in the range |
| | 0 to maxNumSubLayersMinus1, inclusive. |
| VUI | The following fields SHALL have pre-determined values |
| Parameters | as defined: |
| | aspect_ratio_info_present_flag SHALL be set to 1 |
| | aspect_ratio_idc SHALL be set to 1 |
| | OR ALTERNATIVELY |
| | aspect_ratio_idc SHALL be set to 1 or 14 or 15 or |
| | 16. |
| | chroma_loc_info_present_flag SHALL be set |
| | to 0 |
| | video_full_range_flag SHALL be set to 0 |
| | Specification for: |
| | colour_description_present_flag, |
| | overscan_info_present_flag, |
| | low_delay_hrd_flag, |
| | colour_description_present_flag, |
| | colour_primaries, transfer_characteristics, |
| | matrix_coeffs, vui_time_scale, |
| | vui_num_units_in_tick as specified in 9.4.2.4.2 |
| | of CMAF apply |

In one example, video data included in a file generated by data encapsulator 107 may be constrained such that the base layer and an enhancement layer if present have a constant picture rate. It should be noted that in some cases, this constraint may be achieved as illustrated in Table 3, via the constraint: constant_pic_rate_idc[i][j] shall be set equal to 1 for all i, for all j.

In one example, video data included in a file generated by data encapsulator 107 may be constrained such that the base layer and an enhancement layer if present have same number of sub-layers. In one example, each layer shall contain at most two sub-layers, with TemporalId equal to 0 and 1 when there are two sub-layers, and the value of sps_max_sub_layers_minus1 of each SPS shall be set equal to number of sub-layers in the layer minus 1.

In one example, video data included in a file generated by data encapsulator 107 may be constrained such that when a layer has two sub-layers, the sub-layer representation with TemporalId equal to 0 shall have a constant picture rate (as indicated by the presence of elemental_duration_in_tc_minus1[0]), and the picture rate shall be exactly half of that of the entire layer's picture rate (i.e., elemental_duration_in_tc_minus1[0] is equal to 2*elemental_duration_in_tc_minus1[1]).

In one example, video data included in a file generated by data encapsulator 107 may be constrained such that picture cropping shall be indicated by SPS cropping parameters conf_win_left_offset, conf_win_right_offset, conf_win_top_offset, and conf_win_bottom_offset. That is, picture cropping shall be required to be indicated by SPS cropping parameters conf_win_left_offset, conf_win_right_offset, conf_win_top_offset, conf_win_bottom_offset and as such, conf_win_vps_left_offset, conf_win_vps_right_offset, conf_win_vps_top_offset and conf_win_vps_bottom_offset may not be used for inference of the values of the SPS syntax elements, conf_win_left_offset, conf_win_right_offset, conf_win_top_offset and conf_win_bottom_offset, respectively, for each SPS that refers to the VPS. It should be noted that in this example, in the case where conformance_window_vps_flag is equal to 1, a video decoder may determine that a file is non-conforming and perform appropriate action to handle the non-conforming file.

In another example, video data included in a file generated by data encapsulator 107 may be constrained such that picture cropping shall be indicated by vps extension cropping parameters conf_win_vps_left_offset, conf_win_vps_right_offset, conf_win_vps_top_offset, and conf_win_vps_bottom_offset.

In this manner, a multi-layer HEVC presentation encapsulated by a file generated by data encapsulator 107 may be efficiently parsed and/or rendered based on the one or more constraints provided in above. For example, a computing device may expect a particular video codec profile when receiving a file generated by data encapsulator 107. It should be noted that in one example, a presentation application should signal video codec profile and levels of each HEVC Track and Switching Set included in a file generated by data encapsulator 107 using parameters conforming to IETF RFC 6381, The ‘Codecs’ and ‘Profiles’ Parameters for “Bucket” Media Types, August 2011. [RFC6381] and ISO-VIDEO, Annex E Clause 4 also known as section E.4.

It should be noted that only some of the constraints in TABLE 3 may apply. Also some of the constraints may be modified. For example a flag constrained to be 0 may instead constrainted to be 1. The constraint on value of a syntax element described above may be changed. All these are intended to be within the scope of this invention.

Referring again to FIG. 1, interface 108 may include any device configured to receive a file generated by data encapsulator 107 and transmit and/or store the file to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a file to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I2C, or any other logical and physical structure that may be used to interconnect peer devices.

Referring again to FIG. 1, destination device 120 includes interface 122, data decapsulator 123, video decoder 124, and display 126. Interface 122 may include any device configured to receive data from a communications medium. Interface 122 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I2C, or any other logical and physical structure that may be used to interconnect peer devices. Data decapsulator 123 may be configured to decapusulate a file generated by data encaspulator 107. Video decoder 124 may include any device configured to receive a compliant bitstream (e.g., as part of decapsulated data) and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein.

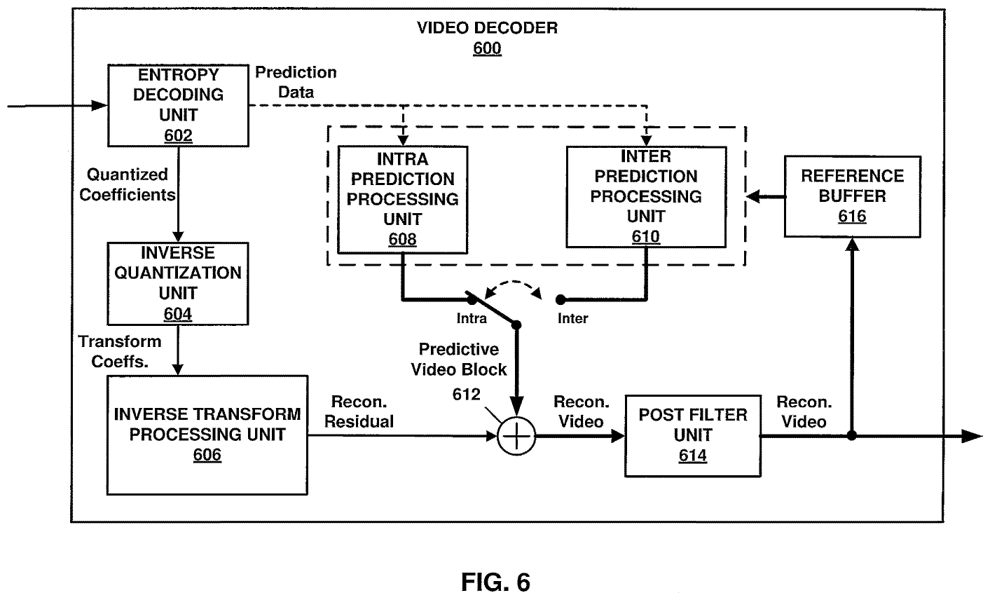

FIG. 6 is a block diagram illustrating an example of a video decoder that may be configured to decode video data according to one or more techniques of this disclosure. In one example, video decoder 600 may be configured to decode transform data and reconstruct residual data from transform coefficients based on decoded transform data. Video decoder 600 may be configured to perform intra prediction decoding and inter prediction decoding and, as such, may be referred to as a hybrid decoder. In the example illustrated in FIG. 6, video decoder 600 includes an entropy decoding unit 602, inverse quantization unit and transform coefficient processing unit 604, intra prediction processing unit 606, inter prediction processing unit 608, summer 610, post filter unit 612, and reference buffer 614. Video decoder 600 may be configured to decode video data in a manner consistent with a video coding system. It should be noted that although example video decoder 600 is illustrated as having distinct functional blocks, such an illustration is for descriptive purposes and does not limit video decoder 600 and/or sub-components thereof to a particular hardware or software architecture. Functions of video decoder 600 may be realized using any combination of hardware, firmware, and/or software implementations.

As illustrated in FIG. 6, entropy decoding unit 602 receives an entropy encoded bitstream. Entropy decoding unit 602 may be configured to decode syntax elements and quantized coefficients from the bitstream according to a process reciprocal to an entropy encoding process. Entropy decoding unit 602 may be configured to perform entropy decoding according any of the entropy coding techniques described above. Entropy decoding unit 602 may determine values for syntax elements in an encoded bitstream in a manner consistent with a video coding standard. As illustrated in FIG. 6, entropy decoding unit 602 may determine a quantization parameter, quantized coefficient values, transform data, and predication data from a bitstream. In the example, illustrated in FIG. 6, inverse quantization unit and transform coefficient processing unit 604 receives a quantization parameter, quantized coefficient values, transform data, and predication data from entropy decoding unit 602 and outputs reconstructed residual data.

Referring again to FIG. 6, reconstructed residual data may be provided to summer 610 Summer 610 may add reconstructed residual data to a predictive video block and generate reconstructed video data. A predictive video block may be determined according to a predictive video technique (i.e., intra prediction and inter frame prediction). Intra prediction processing unit 606 may be configured to receive intra prediction syntax elements and retrieve a predictive video block from reference buffer 614. Reference buffer 614 may include a memory device configured to store one or more frames of video data. Intra prediction syntax elements may identify an intra prediction mode, such as the intra prediction modes described above. Inter prediction processing unit 608 may receive inter prediction syntax elements and generate motion vectors to identify a prediction block in one or more reference frames stored in reference buffer 814. Inter prediction processing unit 608 may produce motion com-pensated blocks, possibly performing interpolation based on interpolation filters. Identifiers for interpolation filters to be used for motion estimation with sub-pixel precision may be included in the syntax elements. Inter prediction processing unit 808 may use interpolation filters to calculate interpolated values for sub-integer pixels of a reference block. Post filter unit 612 may be configured to perform filtering on reconstructed video data. For example, post filter unit 612 may be configured to perform de-blocking and/or Sample Adaptive Offset (SAO) filtering, e.g., based on parameters specified in a bitstream. Further, it should be noted that in some examples, post filter unit 612 may be configured to perform proprietary discretionary filtering (e.g., visual enhancements, such as, mosquito noise reduction). As illustrated in FIG. 6, a reconstructed video block may be output by video decoder 600. In this manner, video decoder 600 may be configured to generate reconstructed video data according to one or more of the techniques described herein.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alter-natively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

### CROSS REFERENCE

This Nonprovisional application claims priority under 35 U.S.C. § 119 on provisional Application No. 62/473,609 on Mar. 20, 2017, the entire contents of which are hereby incorporated by reference.

1.-15. (canceled)

16. A method for decoding a conforming bitstream, the method comprising:
receiving a multi-layer video presentation data including a base layer and an enhancement layer, wherein:
the number of sub-layers of the enhancement layer is equal to the number of sub-layers of the base layer, and
the picture rate for the base layer and the enhancement layer is constant,
decoding the conforming video bitstream, including the base and the enhancement layer having equal number of sub-layers, with a constant picture rate.

17. A method for decoding a conforming bitstream the method comprising:
receiving a multi-layer video presentation data including a layer, wherein when the layer includes two sub-layers, a picture rate of a sub-layer 0 is half of the picture rate of the layer,
decoding the conforming video bitstream including the layer including two sub-layers, wherein the picture rate of the sub-layer 0 is half of the picture rate of the layer.

18. A method for decoding conforming bitstream, the method comprising:
receiving a multi-layer video presentation data including multi-layer video presentation data, wherein picture cropping parameters, for the multi-layer video presentation data, comprising conf_win_right_offset, conf_win_top_offset, conf_win_left_offset and conf_win_botton_offset are set by a sequence parameter set,
decoding the conforming video bitstream when picture cropping is used.
